(19) United States
(12) Patent Application Publication
(10) Pub. No.: US 2004/0039073 A1
(43) Pub. Date: Feb. 26, 2004

(54) Expandable styrene polymers containing carbon particles

(76) Inventor: Guiscard Gluck, Tokyo (JP)

Correspondence Address: KEIL & WEINKAUF, 1350 CONNECTICUT AVENUE, N.W., WASHINGTON, DC, 20036, US

(21) Appl. No.: 10/451,736

(22) PCT Filed: Jan. 11, 2002
(86) PCT No.: PCT/EP02/00212

(30) Foreign Application Priority Data
Jan. 13, 2001 (DE) 101 01 432.5

(51) Int. Cl. C08J 9/00

(52) U.S. Cl. 521/82; 521/132

(57) ABSTRACT

The invention relates to EPS particles that contain graphite particles or carbon black particles and, as expanding agents, 2.2 to 6 wt. % pentane and 1 to 10 wt. % water.

The invention relates to expandable styrene polymer beads (EPS beads) with low pentane content, comprising carbon particles.

Expandable polystyrene foams have been known for a long time and have proven successful in many fields. These foams are produced by foaming EPS beads impregnated with blowing agents, and then fuzing the resultant foam beads to give moldings. A substantial field of application is thermal insulation in the construction industry.

The foam sheets made from EPS beads and used for thermal insulation mostly have densities of at least 30 g/l, since the thermal conductivity of the expanded polystyrene foam is at a minimum at these densities. In order to reduce material usage, it is desirable to use foam sheets with lower densities, in particular ≦15 g/l, for thermal insulation. The industrial production of foams of this type is not difficult. However, foam sheets with relatively low density have drastically impaired thermal insulation capability, with the result that the requirements of, thermal conductivity class 035 (DIN 18 164, Part 1) are not complied with.

Now, it is known that the thermal conductivity of foams can be reduced by incorporating athermanous materials, such as carbon black, metal oxides, metal powder, or pigments. The Patent Applications WO 98/51734, 98/51735, 99/16817, and EP-A 915 127 relate to EPS beads comprising graphite particles and to reduced-thermal-conductivity foams produced therefrom.

Commercially available EPS beads usually comprise pentane as blowing agent, in amounts of from 6 to 7% by weight, and that also applies to the examples in the publications mentioned. However, for environmental protection reasons it is desirable to minimize the content of hydrocarbon blowing agents. For example, U.S. Pat. No. 5,112,875 teaches that it is possible to produce EPS beads with from 2 to 5.5% by weight of hydrocarbon blowing agents if the polystyrene has a quite specific molecular weight distribution. A pentane content of from 3 to 4% by weight is preferred for these “low-pentane” products. However, these EPS beads have the disadvantage of low expandability, meaning that it is impossible to achieve bulk densities below about 20 g/l in one expansion step. To this end it is either necessary to add expensive regulators, e.g. dimeric a-methylstyrene, or to add plasticizers, e.g. higher hydrocarbons, or to use complicated foaming techniques, e.g. pressure-prefoaming or repeated foaming.

U.S. Pat. No. 5,096,931 describes EPS which, as blowing agent, comprises a mixture of water and a C₃-C₆ hydrocarbon and a superabsorber, in particular partially crosslinked polyacrylic acid. However, a disadvantage of polyacrylic acid is that the low pH disrupts the suspension polymerization. The acid also causes branching of the polystyrene chain.

WO 99/48957 describes a process for producing polystyrene comprising water as sole blowing agent, by polymerizing styrene in aqueous suspension in the presence of carbon black or graphite, which act as aids to the emulsification of finely divided water in the suspended styrene droplets. However, the resultant EPS beads cannot be foamed in conventional prefoaming equipment, using superheated steam.

WO 00/15703 describes porous EPS beads which provide easy initiation of foaming and have a bulk density of from 200 to 600 g/l, and comprise a nucleating agent, not more than 2% by weight of an organic blowing agent, e.g. pentane, and not more than 3% by weight of water, based in each case on the styrene polymer. The porous beads have to be produced by initiation of foaming in a separate processing step.

It is an object of the present invention, therefore, to provide EPS beads with relatively low pentane content but good expandability, capable of being processed in a simple manner to give foams with low thermal conductivity.

We have found that this object is achieved by means of EPS which comprises graphite particles or carbon black particles and which comprises, as blowing agent, from 2.2 to 6% by weight of pentane together with from 1 to 10% by weight of water. Surprisingly, this EPS comprising graphite particles or carbon black particles is unlike conventional EPS in having no tendency to exude water during storage, even if its internal water content is up to 4% by eight.

The EPS beads of the invention preferably comprise from 2.5 to 5.0% by weight, in particular from 3.0 to 4.0% by weight, of pentane, and from more than 3 to 8% by weight, in particular from 3.5 to 6% by weight, of water.

The EPS beads are practically free from pores and have a bulk density of more than 600 g/l, preferably more than 650 g/l, in particular more than 700 g/l.

The expandable styrene polymers of the invention in particular comprise, as polymer matrix, homopolystyrene or styrene copolymers with up to 20% by weight, based on the weight of the polymers, of ethylenically unsaturated comonomers, in particular alkylstyrenes, divinylbenzene, acrylonitrile, or a-methylstyrene. Blends made from polystyrene and other polymers, in particular with rubber and polyphenylene ether, are also possible.

Due to the good expandability of the EPS beads, the styrene polymers may have a relatively high viscosity number in the range from 75 to 100 ml·g⁻¹, without addition of plasticizers, which can cause undesirable emissions.

The styrene polymers may comprise the usual and known auxiliaries and additives, such as flame retardants, nucleating agents, UV stabilizers, and antioxidants. The styrene polymers preferably comprise no crosslinked or branched polymers bearing carboxy groups, for example polyacrylic acid.

Additives suitable for lowering the thermal conductivity are carbon particles, such as carbon black and graphite. All of the usual grades of carbon black are suitable, preference being given to flame black with a particle size of from 80 to 120 nm. The amounts preferably used of carbon black are from 2 to 10% by weight. However, graphite is particularly suitable, preference being given to an average particle size of from 0.5 to 200 μm, preferably from 1 to 25 μm, and in particular from 2 to 20 μm, and to a bulk density of from 100 to 500 g/l, and to a specific surface area of from 5 to 20 m²/g. There has been found to be a relationship between the average particle size of the graphite and the amount of water which is introduced into the EPS beads. For example, the amount of water introduced for an average particle size of 30 μm is about 2%, while it is about 4% for a particle size of 10 μm and about 8% for a particle size of 4 μm. Natural graphite or ground synthetic graphite may be used. The amounts of the graphite particles present in the styrene polymer are from 0.1 to 25% by weight, in particular from 0.5 to 8% by weight.

In one preferred embodiment of the invention, the expandable styrene polymers comprise flame retardants, in particular those based on organic bromine compounds. The organic bromine compounds also have a bromine content of ≧70% by weight. Particularly suitable compounds are aliphatic, cycloaliphatic, and aromatic bromine compounds, for example hexabromocyclododecane, pentabromomonochlorocyclohexane, and pentabromophenyl allyl ether.

The action of the bromine-containing flame retardants is considerably improved by adding C—C- or O—O-labile organic compounds. Examples of suitable flame retardant synergists are dicumyl and dicumyl peroxide. A preferred combination is composed of from 0.6 to 5% by weight of organic bromine compound and from 0.1 to 1.0% by weight of the C—C- or O—O-labile organic compound.

The EPS beads of the invention are advantageously produced by conventional suspension polymerization of styrene, where appropriate together with up to 20% of its weight of comonomers, in the presence of from 0.1 to 25%, preferably from 0.5 to 8% by weight, of graphite particles or carbon black particles, and of from 2.5 to 8% by weight, preferably from 3 to 5.5% by weight, of pentane, based in each case on the monomers. The blowing agent here may be added prior to or during the suspension polymerization.

The suspension polymerization is preferably carried out as described in WO 99/16817—in the presence of two peroxides decomposing at different temperatures. The peroxide A decomposing at the lower temperature should have a half-life time of one hour at from 80° C. to 100° C., preferably from 85° C. to 95° C. The peroxide B decomposing at the higher temperature should have a half-life time of one hour at from 110° C. to 140° C., preferably at from 120 to 135° C. Preference is given to peroxides A which form free alkoxy radicals on decomposition. By way of example, mention may be made of tert-butyl 2-ethylperoxyhexanoate, amyl 2-ethylperoxyhexanoate, tert-butyl diethylperoxyacetate, and tert-butyl peroxyisobutanoate. In principle, polymerization using dibenzoyl peroxide is also possible.

The peroxide B used may comprise any of the usual peroxides decomposing at the high temperatures mentioned. Preference is given to those which have no benzoyl groups if the resultant EPS is to be benzene-free. Preferred peroxides B are therefore dicumyl peroxide and aliphatic or cycloaliphatic perketals or monoperoxycarbonates. An example of another compound which may be used is di-tert-amyl peroxide.

The suspension polymerization is advantageously carried out in two temperature stages. For this, the suspension is first heated from 90 to 100° C. within a period of not more than 2 hours, whereupon the peroxide A decomposes and the polymerization begins. The reaction temperature is then permitted to rise, preferably by from 8 to 17° C. per hour, as far as from 120 to 140° C., at which temperature it is held until the residual monomer content has fallen to less than 0.1%. At this temperature the peroxide B decomposes. This procedure permits the production of EPS with low residual monomer contents.

It has been found to be advantageous for the stability of the suspension if a solution of polystyrene (or of an appropriate styrene copolymer) in styrene (or in the mixture of styrene with comonomers) is present at the start of the suspension polymerization. The starting material preferably used here is a styrene solution of polystyrene with a strength of from 0.5 to 30% by weight, in particular from 3 to 20% by weight. Fresh polystyrene may be dissolved in monomers for this purpose, but it is advantageous to use what are known as marginal fractions, screened out during a separation of the range of beads produced during the production of expandable polystyrene, because the beads are too large or too small. In practice, these unusable marginal fractions have diameters greater than 2.0 mm or smaller than 0.2 mm. Use may also be made of recycled polystyrene and recycled polystyrene foam. Another possibility consists in bulk-prepolymerizing styrene as far as from 0.5 to 70% conversion, and suspending the prepolymer together with the carbon black particles or graphite particles in the aqueous phase, and completing the polymerization.

The suspension polymerization produces substantially round beads with an average diameter in the range from 0.2 to 2 mm, within which the carbon black particles or graphite particles have uniform distribution. The usual methods are used to wash them and free them from water adhering to the surface.

It has been found that EPS beads with the inventive content of from 1 to 10% by weight of water are obtained if at least one, and where possible two or more, of the following measures are used:

The shear forces acting during the polymerization should be very low, i.e. stirring should be relatively slow with very low power input to the stirrer.

The suspension should be rapidly heated to from 90 to 100° C., preferably within a period of from 30 to 120 min.

The final temperature should be relatively high, preferably above 120° C., in particular above 130° C.

The drying should proceed relatively rapidly.

The EPS beads are preferably flash-dried after washing, i.e. exposed for a period of less than 1 sec to a stream of air at from 50 to 100° C., in order to remove water adhering to the surface. If the internal water content is above about 4% by weight, the EPS beads should be provided with a surface coating which has high water-absorption capability, e.g. with sodium polyacrylate. If the internal water content is too high there is a risk of undesirable exudation of water during storage.

Some of the pentane can escape from the EPS beads during prolonged storage, in particular in free contact with air. In the foaming process it is important that the pentane content is at least 2.2% by weight.

The EPS beads may be coated with conventional coating agents, e.g. metal stearates, glycerol esters, or fine-particle silicates.

The invention also provides a process for producing styrene polymer foam beads by foaming the EPS beads of the invention, by foaming these in a single step to a bulk density below 200 g/l, preferably below 150 g/l, and in one or more further steps to a bulk density below 50 g/l, preferably below 40 g/l. This is mostly achieved by heating the EPS beads and steam in what are known as prefoamers.

The resultant prefoamed beads may be processed to give polystyrene foams with densities of from 5 to 35 g/l, preferably from 8 to 25 g/l, and in particular from 10 to 15 g/l. For this, the prefoamed particles are placed in molds which do not give a gas-tight seal, treated with steam, and fuzed to give moldings. The moldings can be removed after cooling.

### EXAMPLE 1

21 kg of polystyrene (PS 158 K from BASF) are dissolved in 419 kg of styrene, and 8.5 kg of pulverulent graphite (average particle size 30 μm) (Graphitwerk Kropfmühl AG) are uniformly suspended with admixture of 0.34 kg of tert-butyl 2-ethylperoxyhexanoate, 2.1 kg of dicumyl peroxide, and 2.9 kg of hexabromocyclododecane. The organic phase is introduced into 485 l of deionized water in a pressure-tight 1 m³ stirred tank. The aqueous phase comprises 1.16 kg of sodium pyrophosphate and 2.15 kg of magnesium sulfate. The reaction mixture is heated to 95° C. within a period of 75 min with gentle stirring. It is then heated to 132° C. within a period of 4 h, 5.8 kg of emulsifier K 30/40 (Bayer AG) being added after 2 h and 25 kg of pentane being added after about 2.5 h. Finally, polymerization is completed at 137° C. The EPS beads are washed and flash-dried. The viscosity number of the polystyrene was 83 ml·g⁻¹.

A bead fraction of from 1.6 to 2.5 mm was screened out, and its pentane content and internal water content was determined. The particles were then foamed for a period of 3 min, using steam, and the bulk density was measured. Finally, the foam beads were fuzed in a conventional automatic molding machine. The demolding time was measured, this being the time required for dissipation of the pressure generated within the molding and exerted on the mold after steam is injected to fuze the beads.

### COMPARATIVE EXAMPLE 2c

Example 1 was repeated, but the EPS beads were dried for a period of 8 h, using air at 50° C.

### EXAMPLE 3

Example 1 was repeated, but graphite with average particle size of 10 μm was used, and only 17.5 kg of pentane were added.

TABLE

| | Pentane | | | |
|---|---|---|---|---|
| | content % | Water content | Bulk density | Demolding |
| Ex. | by weight | % by weight | g/l | time sec |
| 1 | 4.5 | 1.86 | 16.1 | 57 |
| 2^{c} | 4.5 | 0.19 | 21.3 | 87 |
| 3 | 3.5 | 4.50 | 18.9 | 51 |

1. An expandable styrene polymer bead (EPS bead) with a bulk density above 600 g/l which comprises from 0.1 to 25% by weight of graphite particles or carbon black particles, and also comprises a volatile blowing agent, wherein the blowing agent is a mixture of
from 2.2 to 6% by weight of pentane and
from 1 to 10% by weight of water,
based in each case on the EPS beads.

2. An EPS bead as claimed in claim 1, which has a bulk density above 650 g/l.

3. An EPS bead as claimed in claim 1 or 2, which comprises
from 2.5 to 5.0% by weight of pentane and
from more than 3 to 8% by weight of water.

4. An EPS bead as claimed in claim 1 or 2, which comprises from 3.0 to 4.0% by weight of pentane and from 3.5 to 6% by weight of water.

5. An EPS bead as claimed in any one of claims 1 to 4, which comprises from 0.5 to 8% by weight of graphite with an average particle size of from 1 to 25 μm.

6. An EPS bead as claimed in any one of claims 1 to 4, which comprises from 2 to 10% by weight of flame black with a particle size of from 80 to 120 nm.

7. An EPS bead as claimed in any one of claims 1 to 6, whose viscosity number is in the range from 75 to 100 ml/g.

8. An EPS bead as claimed in any one of claims 1 to 7, which comprises from 0.6 to 5% by weight, based on the polymer, of an organic bromine compound with a bromine content of ≧70% by weight as flame retardant, and from 0.1 to 1.0% by weight, based on the polymer, of a C—C-labile or O—O-labile organic compound as flame retardant synergist.

9. A process for producing EPS beads as claimed in any one of claims 1 to 8, which comprises polymerizing styrene, where appropriate together with up to 20% by weight of comonomers, in aqueous suspension in the presence of 0.1 to 25% by weight of graphite particles or carbon black particles and from 2.5 to 8% by weight of pentane, based in each case on the monomers, followed, after washing, by exposure to a stream of air at from 50 to 100° C. for less than 1 sec.

10. A process for producing styrene polymer/foam beads by foaming the EPS beads as claimed in any one of claims 1 to 8, which comprises foaming the EPS beads in a single step to a bulk density below 200 g/l and, in further steps, to a bulk density below 50 g/l.

11. A process as claimed in claim 10, wherein foaming takes place in the first step to a bulk density of less than 150 g/l, and in one or more steps to a bulk density of from 5 to 35 g/l.

12. The use of the foam beads produced as claimed in claim 10 for producing foams of density from 5 to 35 g/l which comply with the requirements of thermal conductivity class 035 (DIN 18164, Part 1).
